(19) United States
(12) Patent Application Publication
(10) Pub. No.: US 2026/0236950 A1
(43) Pub. Date: Aug. 13, 2026

(54) POTENTIAL CUSTOMER ESTIMATION DEVICE, POTENTIAL CUSTOMER ESTIMATION SYSTEM, POTENTIAL CUSTOMER ESTIMATION METHOD, AND POTENTIAL CUSTOMER ESTIMATION PROGRAM

(71) Applicant: NEC Corporation, Tokyo (JP)

(72) Inventors: Takehiro KOZUSHI, Tokyo (JP); Masafumi OYAMADA, Tokyo (JP); Genki KUSANO, Tokyo (JP); Masafumi ENOMOTO, Tokyo (JP)

(73) Assignee: NEC Corporation, Tokyo (JP)

(21) Appl. No.: 19/160,058

(22) PCT Filed: Dec. 18, 2023
(86) PCT No.: PCT/JP2023/045173

§ 371 Date: Aug. 27, 2025

(30) Foreign Application Priority Data
Mar. 2, 2023 (JP) 2023-031927

(51) Int. Cl. G06Q 30/0201

(52) U.S. Cl. CPC G06Q 30/02012

(57) ABSTRACT

This potential customer estimation device comprises: a first attribute information extraction unit which extracts first attribute information contained in consumption behavior information of a plurality of customers and which associates said first attribute information with the corresponding customers; a second attribute information identification unit which identifies second attribute information that has been expanded on the basis of the first attribute information and which associates the second attribute information with the corresponding customers; a natural language query reception unit which receives an input of one or more natural language queries that indicate a customer image to be extracted; a relevance degree computation unit which computes a second relevance degree between the one or more natural language queries and the second attribute information; and a potential customer estimation unit which estimates potential customers on the basis of the second relevance degree.

### TECHNICAL FIELD

The present disclosure relates to a potential customer estimation device, a potential customer estimation system, a potential customer estimation method, and a potential customer estimation program.

### BACKGROUND ART

In recent years, techniques related to attempts to analyze consumption behavior data of customers and utilize the data for marketing have been developed. For example, PTL 1 discloses a technique for efficiently providing a search result matching a user's intention and related information related to a query target for an input natural language query. PTL 2 discloses a technique of searching for content by matching images based on a similarity score in response to a search query, and evaluating the matching between the content and the image by an evaluation score. PTL 3 discloses a technique for identifying social emotions in a clause of text such as a user query, an article, a book, a problem ticket, and the like, and generating a natural language text response that conveys or expresses an emotion suitable for the identified social emotion in the clause of an original text.

### CITATION LIST

### Patent Literature

PTL 1: JP 2016-018566 A
PTL 2: JP 2017-220203 A
PTL 3: JP-T-2021-512384 A

### SUMMARY OF INVENTION

### Technical Problem

By analyzing consumption behavior data including consumption behavior histories of a plurality of customers, it is expected that potential customers can be found and utilized for marketing. However, since the information included in the consumption behavior data is limited, it is difficult to find a potential customer with accuracy that can be utilized for marketing even if the consumption behavior data is analyzed.

In view of the above-described problems, an object of the present disclosure is to provide a potential customer estimation device, a potential customer estimation system, a potential customer estimation method, and a potential customer estimation program capable of accurately finding a potential customer.

### Solution to Problem

A potential customer estimation device according to the present disclosure includes:
a first attribute information extraction unit for extracting first attribute information included in consumption behavior information of a plurality of customers and associating the first attribute information with each associated customer;
a second attribute information identification unit for identifying second attribute information extended based on the first attribute information and associating the second attribute information with each associated customer;
a natural language query reception unit for receiving an input of one or more natural language queries indicating a customer image to be extracted;
a relevance calculation unit for calculating a second relevance between the one or more natural language queries and the second attribute information; and
a potential customer estimation unit for estimating a potential customer based on the second relevance.

A potential customer estimation system according to the present disclosure includes:
an attribute information database that stores identification information for identifying a plurality of customers and first attribute information and second attribute information on each customer in association with each other; and
a potential customer estimation device capable of communicating with the attribute information database, in which
the potential customer estimation device:
extracts first attribute information included in consumption behavior information of a plurality of customers and associates the first attribute information with each associated customer;
identifies second attribute information extended based on the first attribute information and associates the second attribute information with each associated customer;
receives an input of one or more natural language queries indicating a customer image to be extracted;
calculates a second relevance between the one or more natural language queries and the second attribute information; and
estimates a potential customer based on the second relevance.

A potential customer estimation method according to the present disclosure causes a computer to execute:
extracting first attribute information included in consumption behavior information of a plurality of customers and associating the first attribute information with each associated customer;
identifying second attribute information extended based on the first attribute information and associating the second attribute information with each associated customer;
receiving an input of one or more natural language queries indicating a customer image to be extracted;
calculating a second relevance between the one or more natural language queries and the second attribute information; and
estimating a potential customer based on the second relevance.

A potential customer estimation program according to the present disclosure causes a computer to execute processing of:
extracting first attribute information included in consumption behavior information of a plurality of customers and associating the first attribute information with each associated customer;
identifying second attribute information extended based on the first attribute information and associating the second attribute information with each associated customer;
receiving an input of one or more natural language queries indicating a customer image to be extracted;
calculating a second relevance between the one or more natural language queries and the second attribute information; and
estimating a potential customer based on the second relevance.

### Advantageous Effects of Invention

According to the present disclosure, it is possible to provide a potential customer estimation device, a potential customer estimation system, a potential customer estimation method, and a potential customer estimation program capable of accurately finding a potential customer.

### BRIEF DESCRIPTION OF DRAWINGS

FIG. 1 is a block diagram illustrating a configuration of a potential customer estimation device according to the present disclosure.
FIG. 2 is a flowchart illustrating an example of a flow of a potential customer estimation method according to the present disclosure.

FIG. 3 is a block diagram illustrating a configuration of a potential customer estimation system according to the present disclosure.

FIG. 4 is a block diagram illustrating a configuration of a service request apparatus capable of communicating with the potential customer estimation system according to the present disclosure.

FIG. 5 is a block diagram illustrating a configuration of a potential customer estimation device according to the present disclosure.

FIG. 6 is a sequence diagram illustrating an operation of the potential customer estimation system in a case where associating attribute information.

FIG. 7 is a diagram illustrating an example of a usage history and second attribute information.

FIG. 8 is a sequence diagram illustrating an operation of a potential customer estimation system in a case where a potential customer is estimated.

FIG. 9 is a diagram illustrating an example of scoring of a phrase.

FIG. 10 is a diagram illustrating an example of scoring of a usage history.

FIG. 11 is a block diagram illustrating a configuration of a potential customer estimation device according to the present disclosure.

FIG. 12 is a sequence diagram showing an operation of the potential customer estimation system in a case where optimizing estimation of a potential customer.

FIG. 13 is a block diagram illustrating a configuration of a potential customer estimation system according to the present disclosure.

FIG. 14 is a block diagram illustrating a configuration of a potential customer estimation device according to the present disclosure.

FIG. 15 is a sequence diagram illustrating an operation of the potential customer estimation system in a case where identifying store attribute information.

FIG. 16 is a sequence diagram illustrating an operation of the potential customer estimation system in a case where creating a DM transmission list.

FIG. 17 is a block diagram illustrating a configuration of a potential customer estimation system according to the present disclosure.

FIG. 18 is a sequence diagram showing an operation of the potential customer estimation system in a case where identifying current second attribute information.

FIG. 19 is a diagram illustrating an example of current and past second attribute information.

FIG. 20 is a sequence diagram illustrating an operation of the potential customer estimation system in a case where estimating a potential customer based on current second attribute information.

FIG. 21 is a block diagram illustrating a hardware configuration of a computer.

### EXAMPLE EMBODIMENT

Hereinafter, example embodiments of the present disclosure will be described in detail with reference to the drawings. In the drawings, the same or associated elements are denoted by the same reference signs, and repeated description of the elements will be omitted to clarify the description as necessary.

### First example Embodiment

FIG. 1 is a block diagram illustrating a configuration of a potential customer estimation device according to the present disclosure. A potential customer estimation device 100 includes a first attribute information extraction unit 110, a second attribute information identification unit 120, a natural language query reception unit 130, a relevance calculation unit 140, and a potential customer estimation unit 150.

Upon receiving consumption behavior information of the plurality about customers from a service request apparatus (not illustrated), the first attribute information extraction unit 110 extracts first attribute information included in the consumption behavior information, and stores the first attribute information in an attribute information database (not illustrated) in association with each associated customer. The consumption behavior information is information including a consumption behavior history of the customer, and is specifically, for example, a store name and a date and time in a case where the product is purchased. It is assumed that the consumption behavior information includes a customer ID for identifying a customer. The consumption behavior information may include a demographic attribute of the customer in addition to the consumption behavior history of the customer. The demographic attribute is a demographic attribute, and is, for example, age, gender, or the like. The first attribute information is information that can be related to a consumption behavior of the customer and is included in the consumption behavior information. Specifically, the first attribute information may include, for example, information related to a store, such as a name of a store where a customer has purchased a product, a location of the store, a business category of the store, and a purchase amount in the store.

Furthermore, the first attribute information may include information regarding demographic attributes such as gender and age. The first attribute information may include information related to a product such as a product name of a product purchased by a customer and product attribute information given to the product in advance.

The second attribute information identification unit 120 identifies second attribute information extended based on the first attribute information extracted by the first attribute information extraction unit 110, and stores the second attribute information in the attribute information database in association with each associated customer. The second attribute information is a psychographic attribute extended based on the first attribute information. The second attribute information identification unit 120 is set to identify the second attribute information in a case where acquiring the first attribute information.

Upon receiving the natural language query from the service request apparatus, the natural language query reception unit 130 receives an input of the natural language query. The natural language query is a natural language indicating a customer image to be extracted, that is, a potential customer image. The number of natural language queries may be one or more. Furthermore, the natural language query may be a word or a sentence.

The relevance calculation unit 140 calculates a second relevance between the natural language query received by the natural language query reception unit 130 and the second attribute information about each customer. The second relevance is a numerical value indicating a relevance between the natural language query and the second attribute information. The second relevance is expressed as a numerical value within a predetermined range. The second relevance is expressed as, for example, a numerical value of 0 or more and 1 or less, and may be a larger numerical value in a case where the relevance is high as compared with a case where the relevance is low. The second relevance may be expressed as a numerical value indicating the presence or absence of relevance. The second relevance may be expressed as, for example, 1 in a case where considered to be relevant and 0 in a case where considered not to be relevant. The potential customer estimation unit 150 estimates a potential customer based on the second calculation unit calculated by the relevance calculation unit 140.

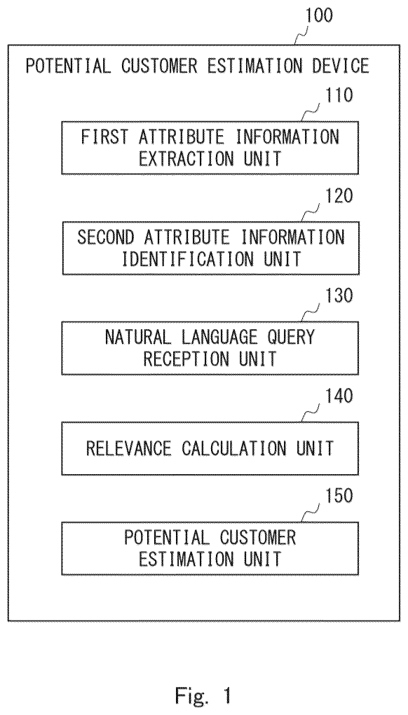

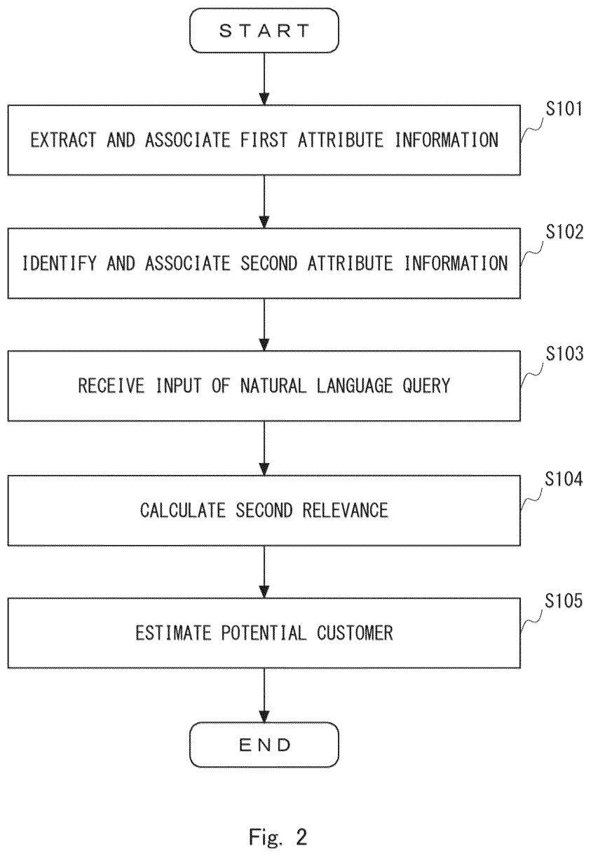

FIG. 2 is a flowchart illustrating a flow of a potential customer estimation method according to the present disclosure. First, the first attribute information extraction unit 110 extracts the first attribute information included in the consumption behavior information about the plurality of customers and associates the first attribute information with each associated customer (step S101). Next, the second attribute information identification unit 120 identifies the second attribute information extended based on the first attribute information extracted in step S101 and associates the second attribute information with each associated customer (step S102). Next, the natural language query reception unit 130 receives an input of one or more natural language queries indicating a customer image to be extracted (step S103). Next, the relevance calculation unit 140 calculates the second relevance between the natural language query received in step S103 and the second attribute information identified in step S102 (step S104). Next, the potential customer estimation unit 150 estimates a potential customer based on the second relevance calculated in step S104 (step S105).

As described above, in the potential customer estimation method according to the first example embodiment, the second attribute information extended based on the first attribute information is identified. Therefore, the potential customer can be accurately estimated using the second attribute information.

The potential customer estimation device 100 includes a processor, a memory, and a storage device as components not illustrated. The storage device stores a computer program in which the processing of the potential customer estimation method according to the present example embodiment is implemented. Then, the processor reads a computer program from the storage device to the memory and executes the computer program. As a result, the processor implements the functions of the first attribute information extraction unit 110, the second attribute information identification unit 120, the natural language query reception unit 130, the relevance calculation unit 140, and the potential customer estimation unit 150.

Alternatively, each component of the potential customer estimation device 100 may be achieved by dedicated hardware. A part or all of each component of each device may be achieved by a general-purpose or dedicated circuitry, a processor, or the like, or a combination thereof. These components may be configured with a single chip or may be configured with a plurality of chips connected via a bus. Some or all of the components of each apparatus may be implemented by a combination of the above circuit or the like and a program. Furthermore, as the processor, a central processing unit (CPU), a graphics processing unit (GPU), a field-programmable gate array (FPGA), a quantum processor (quantum computer control chip), or the like can be used.

In a case where some or all of the components of the potential customer estimation device 100 are achieved by a plurality of information processing apparatuses, circuits, and the like, the plurality of information processing apparatuses, circuits, and the like may be arranged in a centralized manner or in a distributed manner. For example, the information processing apparatuses, the circuits, or the like may be implemented in the form of a client server system, a cloud computing system, or the like in which they are connected to each other through a communication network. Furthermore, the function of the potential customer estimation device 100 may be provided in a software as a service (Saas) format.

### Second Example Embodiment

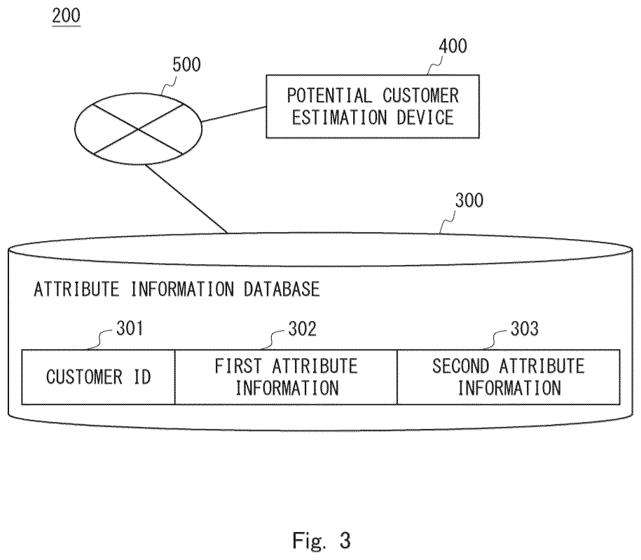

FIG. 3 is a block diagram illustrating a configuration of a potential customer estimation system 200 according to the present disclosure. The potential customer estimation system 200 is an information system that estimates a potential customer using a consumption behavior history of a customer owned by a credit card company. Specifically, the potential customer estimation system 200 estimates a potential customer by using a credit card usage history. The potential customer estimation system 200 includes an attribute information database 300 and a potential customer estimation device 400. The attribute information database 300 and the potential customer estimation device 400 are communicably connected via a network 500. Here, the network 500 is a wired or wireless communication line and may include the Internet.

The attribute information database 300 stores a first attribute information 302 and a second attribute information 303 in association with a customer ID 301. The customer ID 301 is information for identifying a customer of the credit card company, and is, for example, a unique numerical value allocated to each customer. The first attribute information 302 is information included in a credit card usage history or the like, and is, for example, a name, a location, and a business category of a store where a customer uses a credit card, a purchase amount at the store, or the like. The second attribute information 303 is a psychographic attribute extended based on the first attribute information 302.

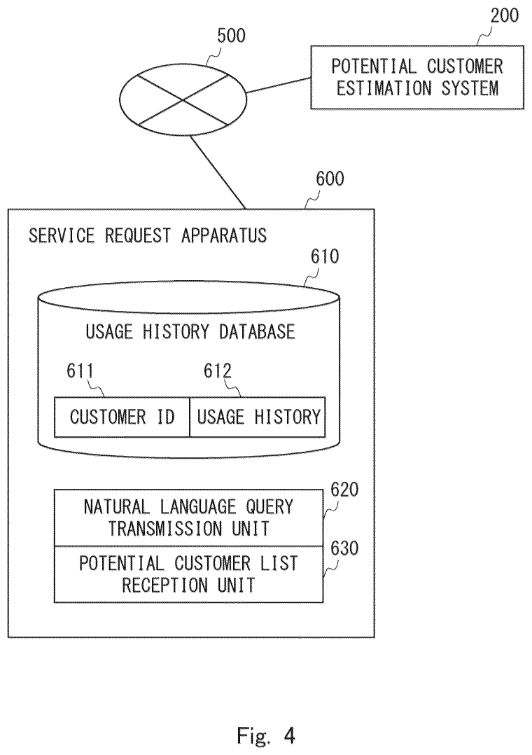

FIG. 4 is a block diagram illustrating a configuration of a service request apparatus 600 capable of communicating with the potential customer estimation system 200 according to the present disclosure. As illustrated in FIG. 4, the potential customer estimation system 200 is connected to the service request apparatus 600. The service request apparatus 600 is an information processing apparatus that requests the potential customer estimation system 200 to estimate a potential customer, and is installed in, for example, a credit card company. Although details will be described later, the service request apparatus 600 transmits a natural language query to the potential customer estimation system 200 and receives a potential customer list from the potential customer estimation system 200.

The service request apparatus 600 includes a usage history database 610, a natural language query transmission unit 620, and a potential customer list reception unit 630. The usage history database 610 stores a usage history 612 in association with a customer ID 611. The customer ID 611 is information for identifying a customer of a credit card company, that is, a person who uses a credit card, and is, for example, a unique numerical value allocated to each customer. The usage history 612 is a usage history of a credit card of a customer, and includes, for example, a store name of a credit card usage, a usage date and time, a usage amount, and the like. The natural language query transmission unit 620 is communication means that transmits a natural language query to the potential customer estimation system 200. Upon receiving the natural language query, the potential customer estimation system 200 is configured to output a potential customer list. The potential customer list reception unit 630 is communication means that receives the potential customer list from the potential customer estimation system 200.

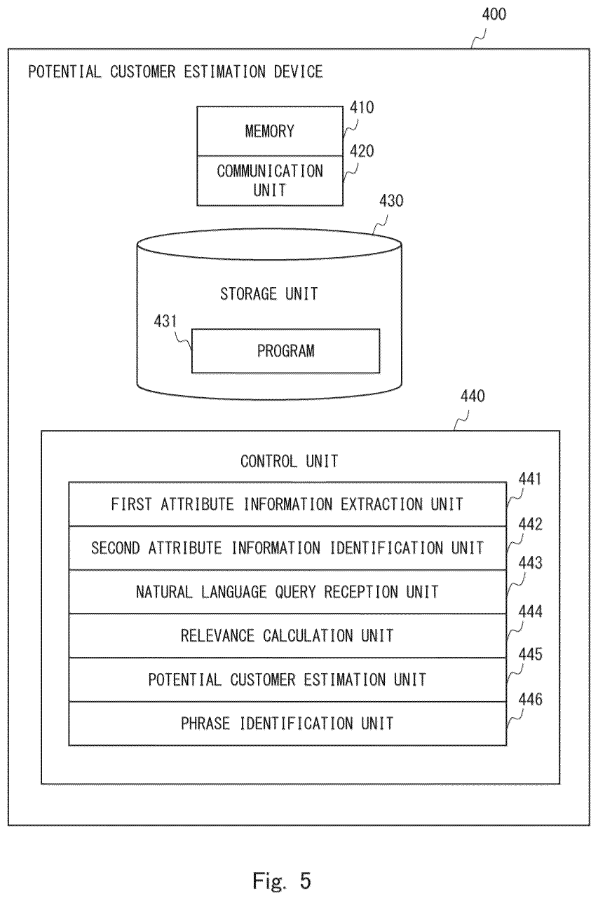

Next, a configuration of the potential customer estimation device 400 according to the present disclosure will be described with reference to FIG. 5. FIG. 5 is a block diagram illustrating a configuration of the potential customer estimation device 400 according to the present disclosure. The potential customer estimation device 400 is an example of the potential customer estimation device 100 described above. The potential customer estimation device 400 is an information processing device that performs identification and association of attribute information, potential customer estimation processing, and the like, and is, for example, a server device achieved by a computer. The potential customer estimation device 400 may be made redundant by a plurality of servers, and each functional block may be achieved by a plurality of computers. The potential customer estimation device 400 includes a memory 410, a communication unit 420, a storage unit 430, and a control unit 440.

The memory 410 is a storage region for temporarily storing processing contents of the control unit 440, and is, for example, a volatile storage device such as a random access memory (RAM). The communication unit 420 is an interface that communicates with the outside of the potential customer estimation device 400. The storage unit 430 is a storage device that stores a program 431 and the like. The program 431 is a computer program in which the potential customer estimation processing according to the present disclosure is implemented.

The control unit 440 includes at least a first attribute information extraction unit 441, a second attribute information identification unit 442, a natural language query reception unit 443, a relevance calculation unit 444, and a potential customer estimation unit 445, and may further include a phrase identification unit 446. The control unit 440 is a control device that controls the operation of the potential customer estimation device 400, and is, for example, a processor such as a CPU. The control unit 440 reads a program 431 from the storage unit 430 into the memory 410 and executes the program. As a result, the control unit 440 achieves functions as the first attribute information extraction unit 441, the second attribute information identification unit 442, the natural language query reception unit 443, the relevance calculation unit 444, the potential customer estimation unit 445, and the phrase identification unit 446.

As preprocessing of the potential customer estimation processing, the potential customer estimation device 400 receives the usage history including the customer ID from the service request apparatus 600, and associates the first attribute information 302 and the second attribute information 303 with the customer ID 301. In a case where receiving the usage history including the customer ID from the service request apparatus 600, the first attribute information extraction unit 441 extracts the first attribute information from the received usage history, and stores the first attribute information in the attribute information database 300 in association with the customer ID. The second attribute information identification unit 442 stores the attribute information extended based on the first attribute information extracted by the first attribute information extraction unit 441 in the attribute information database 300 as the second attribute information in association with the customer ID.

In a case where requesting estimation of a potential customer, the service request apparatus 600 transmits a potential customer estimation request including a natural language query indicating a customer image to be extracted to the potential customer estimation device 400. Upon receiving the potential customer estimation request, the natural language query reception unit 443 receives the natural language query. A natural language query is one or more natural languages. The phrase identification unit 446 identifies a phrase from the natural language query received by the natural language query reception unit 443. The phrase is a natural language used for calculating the relevance, and is, for example, a word or a combination of words.

The relevance calculation unit 444 may calculate at least the second relevance and may further calculate the first relevance. The first relevance is a numerical value representing the relevance between the natural language query or phrase and the first attribute information. The second relevance is a numerical value representing the relevance between the natural language query or phrase and the second attribute information. The potential customer estimation unit 445 estimates a potential customer based on the second relevance, and outputs a potential customer list to the service request apparatus 600. The potential customer estimation unit 445 may estimate the potential customer based on the first relevance and the second relevance.

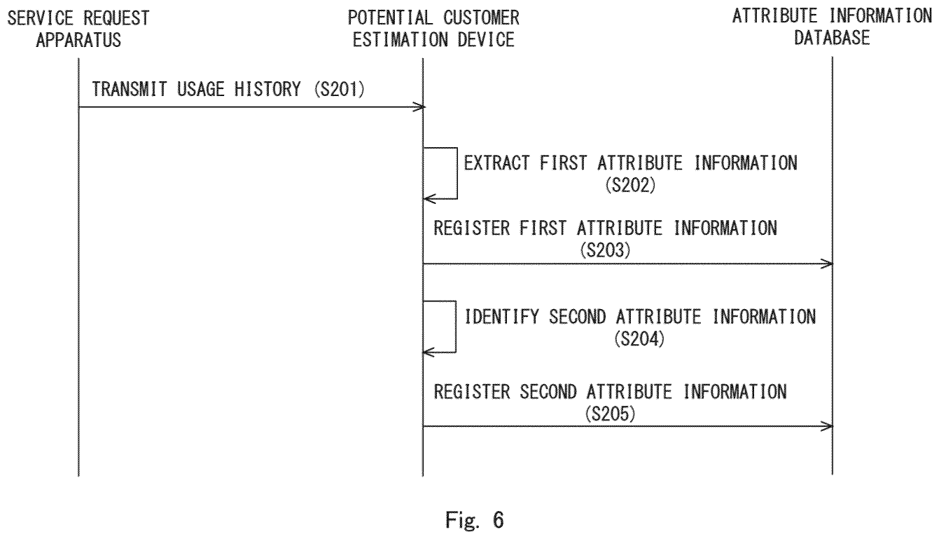

Next, an example of the operation of the potential customer estimation system 200 at the time of pre-processing, that is, at the time of associating attribute information will be described with reference to FIG. 6. FIG. 6 is a sequence diagram illustrating an operation of the potential customer estimation system 200 in a case where associating attribute information. First, a person in charge of the credit card company transmits the usage history stored in the service request apparatus 600 together with the associated customer ID to the potential customer estimation device 400 (step S201). At this time, from the viewpoint of personal information protection, the usage history does not include personal information such as an address and a name of the customer. The usage history may include information that cannot be independently identified, such as age and gender of the customer.

Next, the first attribute information extraction unit 441 extracts the first attribute information from the usage history received in step S201 (step S202), and registers the first attribute information in the attribute information database 300 in association with the customer ID included in the usage history (step S203). Next, the second attribute information identification unit 442 identifies the second attribute information based on the first attribute information extracted in step S202 (step S204), and registers the second attribute information in the attribute information database 300 in association with the customer ID included in the usage history (step S205). The potential customer estimation device 400 performs each processing of steps S202 to S205 on the use histories of a plurality of customers.

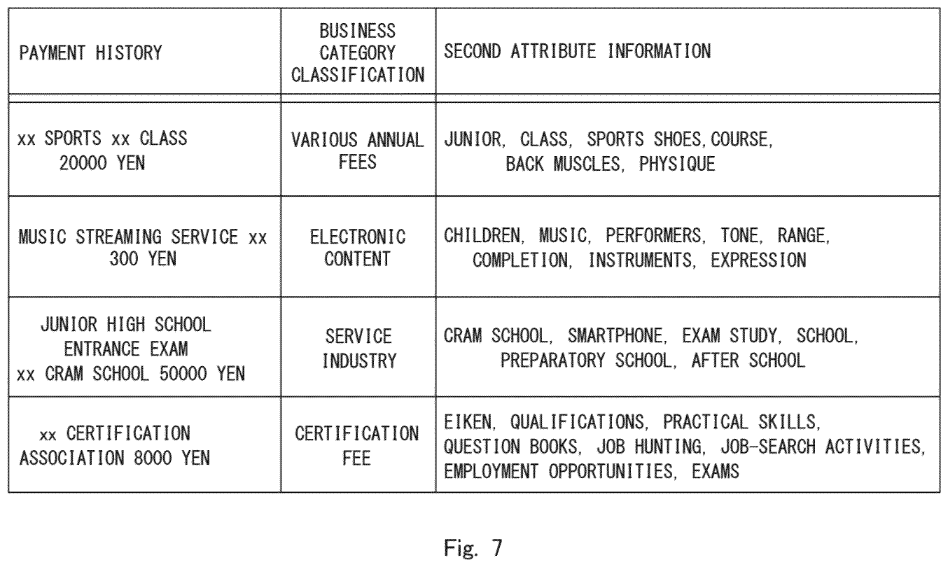

FIG. 7 is a diagram illustrating an example of the usage history and the second attribute information. A payment history and a business category classification illustrated in FIG. 7 are an example of a usage history transmitted to the potential customer estimation device 400 as a usage history for one person. The payment history illustrated in FIG. 7 is a history of payment made by one customer using a credit card within a predetermined period. As illustrated in FIG. 7, the payment history includes the name of the store where the payment has been made and the payment amount. The business category classification illustrated in FIG. 7 is a business category classification given by a credit card company to a store where a customer makes a payment. A credit card company usually assigns a business category classification indicating a business category of an affiliated store to an affiliated store that has introduced a credit card payment system. As illustrated in FIG. 7, the usage history transmitted from the service request apparatus 600 to the potential customer estimation device 400 may include a business category classification assigned by a credit card company.

Upon receiving the usage history illustrated in FIG. 7, the first attribute information extraction unit 441 extracts the name, the business category classification, and the like of the store where the customer made payment as the first attribute, and registers the first attribute in the attribute information database 300 in association with the customer ID. The second attribute information illustrated in FIG. 7 is the second attribute information identified by the second attribute information identification unit 442. The second attribute information identification unit 442 identifies, as the second attribute information, a word extended based on, for example, the name of the store where the customer made payment and the business category classification.

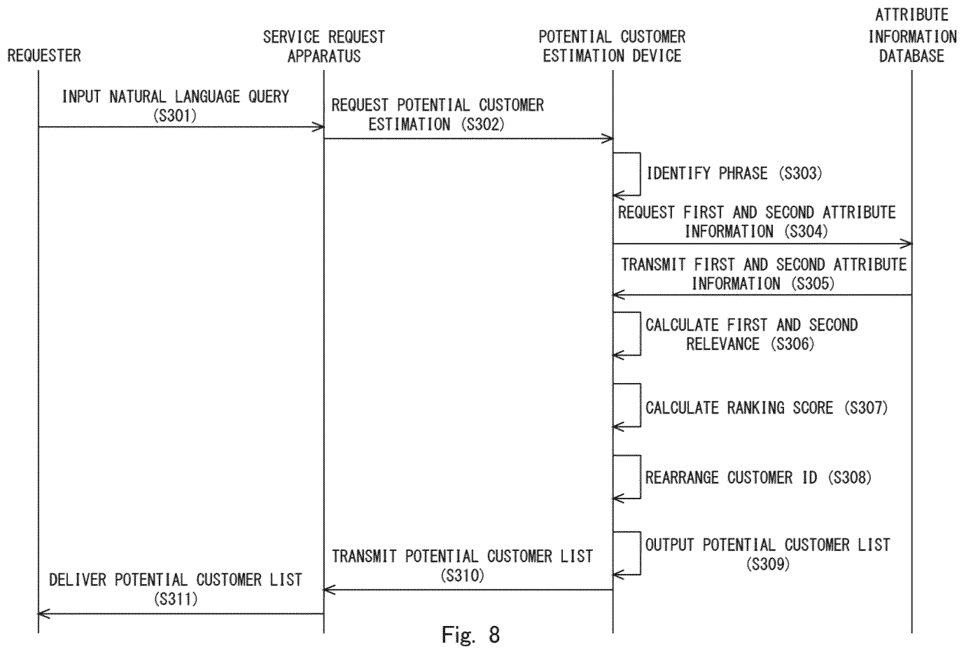

Next, an example of the operation of the potential customer estimation system 200 at the time of the present processing, that is, at the time of estimating a potential customer will be described with reference to FIG. 8. FIG. 8 is a sequence diagram illustrating an operation of the potential customer estimation system in a case where estimating a potential customer. A requester illustrated in FIG. 8 is a person who wishes to estimate a potential customer, and is, for example, a business operator who wishes to transmit a direct mail (DM) that prompts the customer to visit store of the requester. First, the requester inputs one or more natural language queries to the service request apparatus 600 (step S301). Step S301 may be performed in any manner as long as the natural language query can be input to the service request apparatus 600. For example, in step S301, a person in charge of a credit card company may hear from a requester about a customer image to be extracted, and the person in charge may input a natural language query to the service request apparatus 600 based on the content of the hearing.

Next, the natural language query transmission unit 620 transmits a potential customer estimation request including the natural language query to the potential customer estimation device 400 (step S302). The phrase identification unit 446 identifies one or more phrases from the natural language query included in the potential customer estimation request (step S303). For example, in a case where the received natural language query is one sentence “a person who is highly interested in management of a company and is engaged in self-development”, the phrase identification unit 446 identifies three phrases “management”, “interest: strong”, and “self-development: strong”.

Next, the relevance calculation unit 444 requests the attribute information database 300 for the first attribute information and the second attribute information of each customer (step S304). The attribute information database 300 transmits the first attribute information, the second attribute information, and the associated customer ID to the potential customer estimation device 400 in response to the request (step S305). Next, the relevance calculation unit 444 calculates the first relevance and the second relevance (step S306). Next, the relevance calculation unit 444 calculates a ranking score based on the first relevance and the second relevance (step S307). The relevance calculation unit 444 performs steps S304 to S307 for each of a plurality of customers.

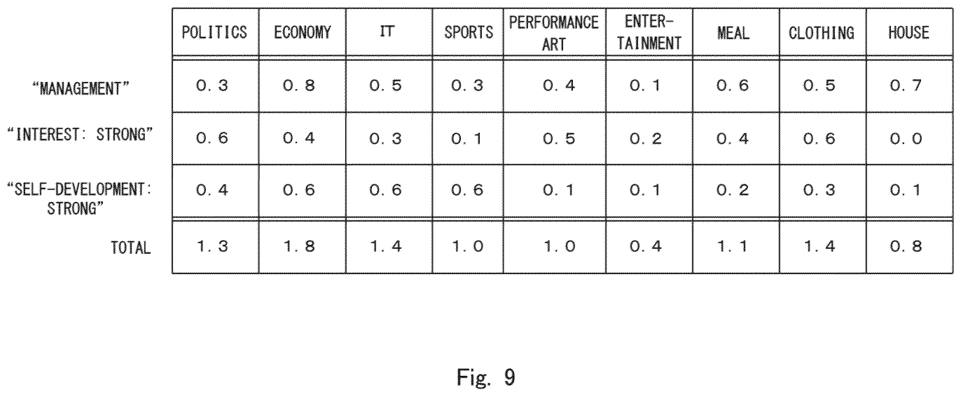

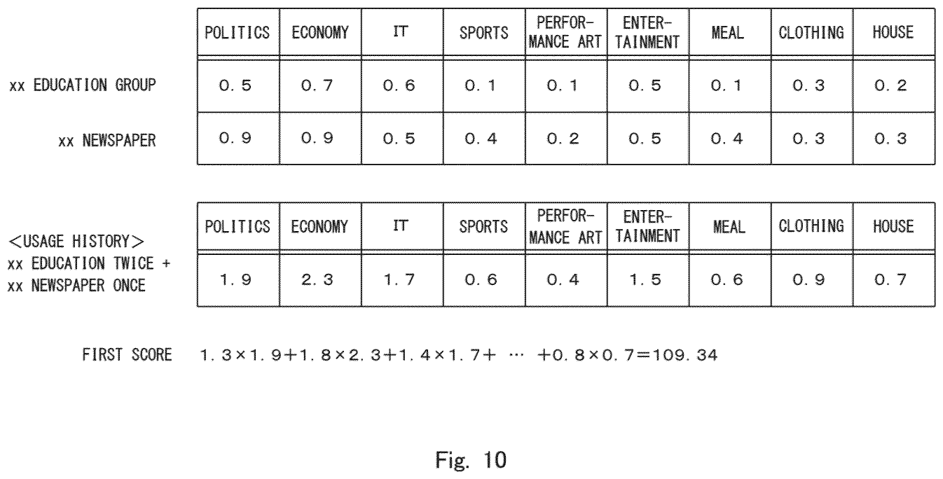

An example of the operation of the relevance calculation unit 444 in a case where calculating the first relevance, the second relevance, and the ranking score will be described with reference to FIGS. 9 and 10. FIG. 9 is a diagram illustrating an example of scoring of a phrase. FIG. 10 is a diagram illustrating an example of scoring of a usage history. In a case where calculating the first relevance and the second relevance, the relevance calculation unit 444 first calculates an index for each of a plurality of preset entry words. The plurality of entry words is words set for scoring, and is, for example, words indicating a large number of different fields. In the example illustrated in FIG. 9, the plurality of entry words is nine words of “politics”, “economy”, “IT”, “sports”, “performance art”, “entertainment”, “meal”, “clothing”, and “house”. As illustrated in FIG. 9, the relevance calculation unit 444 calculates an entry word relevance for each phrase. The entry word relevance is a numerical value representing the relevance to each entry word. In the example illustrated in FIG. 9, the entry word relevance is represented as a numerical value of 0 or more and 1 or less, and in a case where the relevance is high, the numerical value is larger than that a case where the relevance is low. The entry word relevance may be expressed as a numerical value indicating the presence or absence of association. For example, the entry word relevance may be expressed as 1 in a case where the entry word relevance is considered to be associated, and may be expressed as 0 in a case where the entry word relevance is considered not to be associated. Next, as illustrated in FIG. 9, the relevance calculation unit 444 adds the entry word relevance calculated for each phrase for each entry word to calculate the entry word relevance for the entire natural language query for each entry word.

Next, as illustrated in FIG. 10, the relevance calculation unit 444 calculates the entry word relevance with respect to the usage history extracted as the first attribute information. Specifically, first, the relevance calculation unit 444 calculates an entry word relevance for each of the plurality of store names (first attribute information) included in the usage history. Next, the relevance calculation unit 444 calculates the entry word relevance to the entire usage history for each entry word by adding a numerical value obtained by multiplying the number of payments at each store by the entry word relevance calculated for the store for each entry word. Next, the relevance calculation unit 444 calculates the first relevance by multiplying the entry word relevance to the entire natural language query by the entry word relevance to the entire usage history for each entry word. Next, the relevance calculation unit 444 calculates the first score by adding the first relevance calculated for each entry word. In this manner, the relevance calculation unit 444 scores the first relevance.

The relevance calculation unit 444 also scores the second relevance similarly to the first relevance. Specifically, the relevance calculation unit 444 calculates the entry word relevance for each entry word for each piece of the second attribute information, and then adds the entry word relevance for each entry word to calculate the title relevance for the entire second attribute information. Next, the relevance calculation unit 444 calculates the second relevance for each entry word by multiplying the entry word relevance for the entire natural language query by the entry word relevance for the entire second attribute information for each entry word. The relevance calculation unit 444 calculates the second score by adding the second relevance calculated for each entry word. Next, the relevance calculation unit 444 calculates a ranking score, that is, a score by adding the first score and the second score. The scoring method is not limited to the above-described method, and can be appropriately changed.

Returning to FIG. 8, the description will be continued.

The potential customer estimation unit 445 rearranges the customer IDs in descending order of the ranking scores calculated in step S307 (step S308). The potential customer estimation unit 445 outputs a customer ID whose ranking score is a predetermined numerical value or more as a potential customer list (step S309), and transmits the potential customer list to the service request apparatus 600 (step S310). Upon receiving the potential customer list, the person in charge of operating the service request apparatus 600 delivers the potential customer list to the requester (step S311). In a case where the potential customer list is delivered, the requester transmits the DM based on the delivered potential customer list, for example.

As described above, in the potential customer estimation method according to the second example embodiment, the relevance between the second attribute information extended based on the consumption behavior history of the customer and the natural language query is calculated. Therefore, it is possible to accurately find a customer having a high relevance with the natural language query, that is, a potential customer. In steps S301 to S311 described above, the ranking score, that is, the score is calculated, and the potential customer is extracted by ranking based on the score. However, the extraction of the potential customer is not limited to the above, and the potential customer may be extracted based on the second relevance. Specifically, for example, a customer whose average value of the second relevance calculated for each entry word is a predetermined numerical value or more may be extracted as a potential customer.

### Third Example Embodiment

A third example embodiment is a modified example of the second example embodiment described above. In the third example embodiment, estimation accuracy is improved using a usage history after estimation of a customer estimated as a potential customer. Hereinafter, description of a potential customer estimation device 1200 according to third example embodiment overlapping with the second example embodiment and the like will be appropriately omitted.

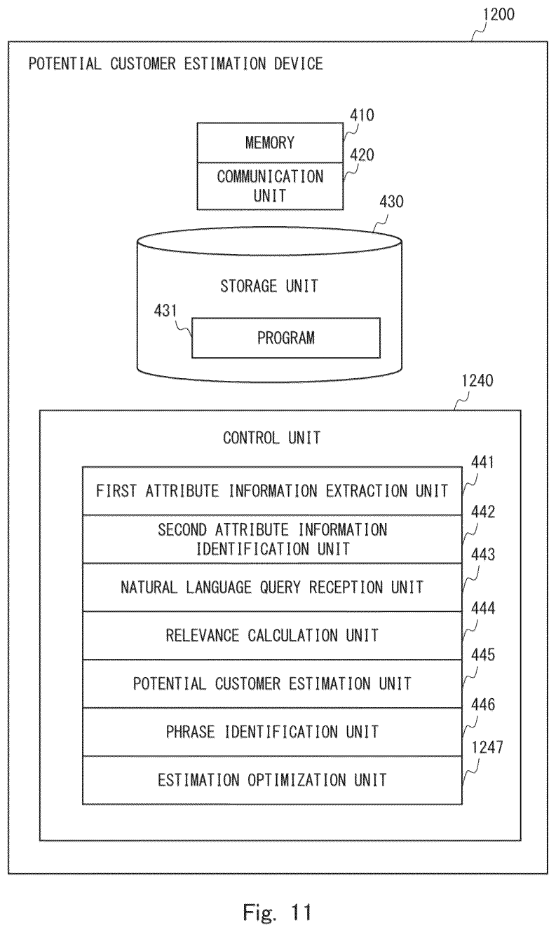

FIG. 11 is a block diagram illustrating a configuration of the potential customer estimation device 1200 according to the present disclosure. As illustrated in FIG. 11, the potential customer estimation device 1200 is different from the potential customer estimation device 400 illustrated in FIG. 3 in including a control unit 1240 instead of the control unit 440. The control unit 1240 includes an estimation optimization unit 1247 in addition to the configuration included in the control unit 440. The estimation optimization unit 1247 evaluates whether the estimation of the potential customer is proper based on the behavior history after the estimation of the potential customer, and enhances the estimation accuracy of the potential customer.

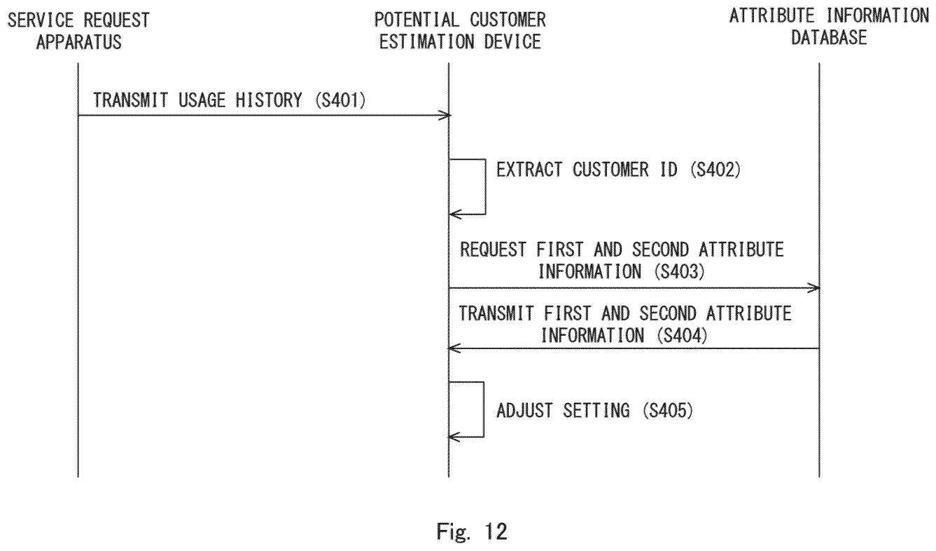

FIG. 12 is a sequence diagram illustrating an operation of the potential customer estimation system in a case where optimizing the estimation of the potential customer. First, the service request apparatus 600 transmits the usage history of the customer output as the potential customer to the potential customer estimation device 1200 (step S401). The usage history transmitted in step S401 includes the customer ID and the usage history of the credit card after the potential customer estimation. Upon receiving the usage history, the estimation optimization unit 1247 extracts the customer ID included in the usage history (step S402). Next, the estimation optimization unit 1247 requests the first attribute information and the second attribute information associated with the customer ID extracted in step S402 from the attribute information database 300 (step S403). The attribute information database 300 transmits the first attribute information, the second attribute information, and the associated customer ID to the potential customer estimation device 1200 in response to the request (step S404).

Next, the estimation optimization unit 1247 adjusts the setting of the potential customer estimation unit 445 according to the content of the usage history received in step S401 (step S405). For example, in a case where the customer estimated as the potential customer has performed the consumption behavior matching the estimated content, the estimation optimization unit 1247 determines that the estimation of the potential customer is proper. In this case, the estimation optimization unit 1247 changes the setting of the relevance calculation unit 444 and the like in such a way that the relevance with the natural language query used at the time of the potential customer estimation is calculated to be higher for the first attribute information and the second attribute information given to the customer. In a case where the customer estimated as the potential customer has not performed the consumption behavior matching the estimated content, the estimation optimization unit 1247 determines that the estimation of the potential customer is not appropriate. In this case, the estimation optimization unit 1247 changes the setting of the relevance calculation unit 444 and the like in such a way that the relevance with the natural language query used at the time of the potential customer estimation is calculated to be lower for the first attribute information and the second attribute information given to the customer.

As described above, in the potential customer estimation method according to the third example embodiment, whether the estimation is proper after the potential customer estimation is evaluated, and the setting of the potential customer estimation device 1200 is changed according to the evaluation. Therefore, the accuracy of the potential customer estimation can be further improved.

### Fourth Example Embodiment

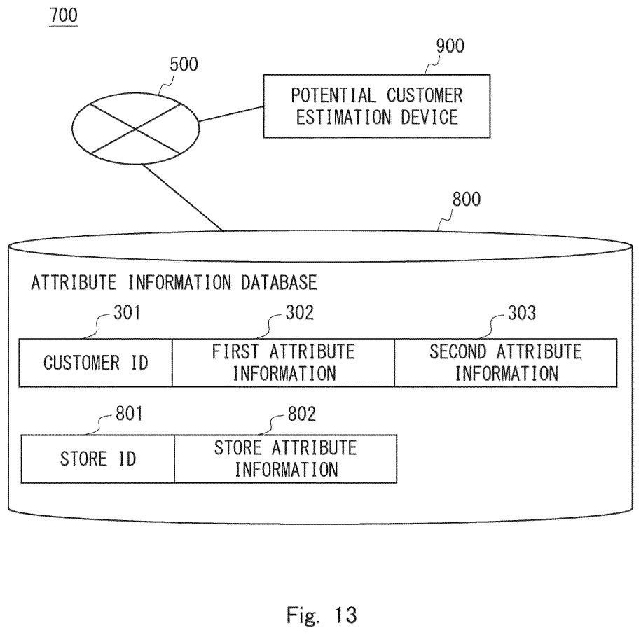

A fourth example embodiment is a modified example of the second example embodiment described above. In the fourth example embodiment, a combination of a store and a customer having high similarity is estimated using store attribute information extended based on business category information such as a store name. FIG. 13 is a block diagram illustrating a configuration of a potential customer estimation system 700 according to the present disclosure. As illustrated in FIG. 13, the potential customer estimation system 700 is different from the potential customer estimation system 200 illustrated in FIG. 3 in that an attribute information database 800 is provided instead of the attribute information database 300 and a potential customer estimation device 900 is provided instead of the potential customer estimation device 400.

As illustrated in FIG. 13, the attribute information database 800 stores the first attribute information 302 and the second attribute information 303 in association with the customer ID 301, and stores store attribute information 802 in association with store ID 801. The store ID 801 is information for identifying an affiliated store of the credit card company, and is, for example, a unique numerical value allocated to each affiliated store. The store attribute information 802 is information regarding a business category of an affiliated store, and includes, for example, attribute information extended from the business category information about the affiliated store. The business category information is information regarding a business category of a store, and is, for example, a business category classification given to an affiliated store by a credit card company, a store name of the affiliated store, a location of the affiliated store, and the like. The store attribute information 802 may include business category information in addition to the extended attribute information.

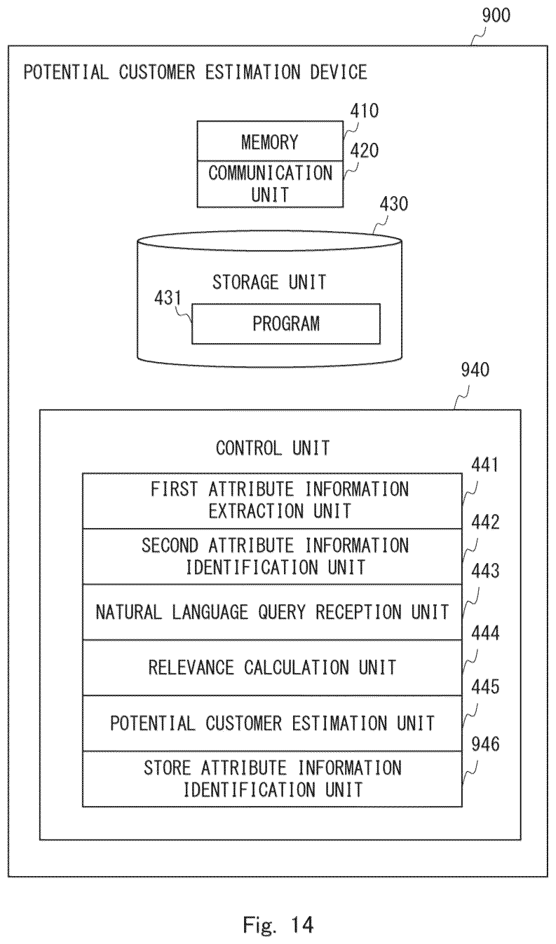

FIG. 14 is a block diagram illustrating a configuration of a potential customer estimation device 900 according to the present disclosure. The potential customer estimation device 900 is different from the potential customer estimation device 400 illustrated in FIG. 3 in that a control unit 940 is provided instead of the control unit 440. The control unit 940 includes a store attribute information identification unit 946 in addition to the configuration included in the control unit 440. The store attribute information identification unit 946 identifies store attribute information extended based on the business category information of each store (each affiliated store) and stores the store attribute information in the attribute information database 800 in association with the store ID. In the fourth example embodiment, for example, a credit card company requests the potential customer estimation system 700 to create a DM transmission list in order to propose DM transmission to its affiliated store.

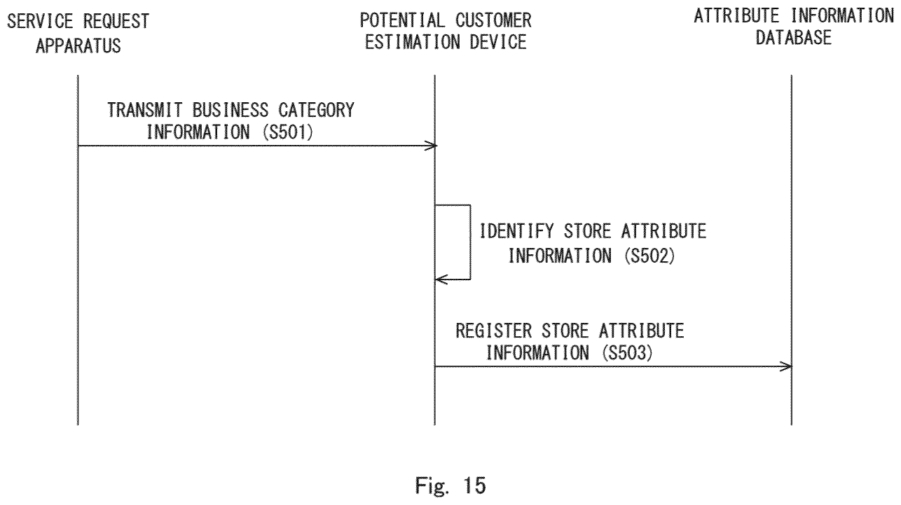

Next, an example of the operation of the potential customer estimation system 700 at the time of pre-processing, that is, at the time of identifying the store attribute information will be described with reference to FIG. 15. FIG. 15 is a sequence diagram illustrating an operation of the potential customer estimation system 700 in a case where identifying the store attribute information. First, the person in charge of the credit card company transmits the business category information of the affiliated store stored in the service request apparatus 600 to the potential customer estimation device 900 (step S501). The business category information transmitted in step S501 includes a store ID of an affiliated store associated to the business category information. Next, the store attribute information identification unit 946 identifies the store attribute information from the business category information received in step S501 (step S502), and registers the store attribute information in the attribute information database 800 in association with the store ID included in the business category information (step S503). The potential customer estimation device 900 performs each processing of step S502 and step S503 on the business category information of the plurality of affiliated stores.

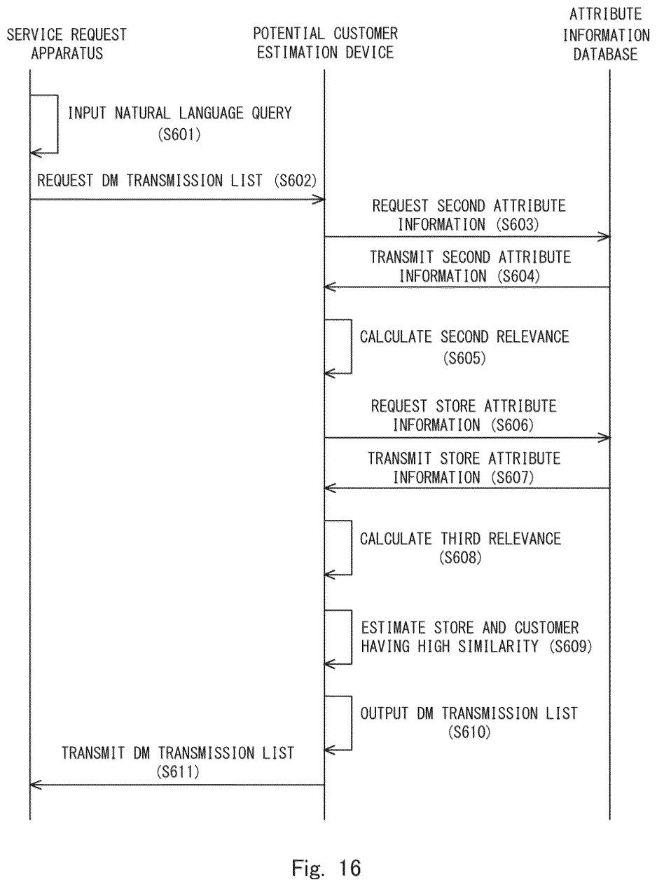

Next, an example of the operation of the potential customer estimation system 700 at the time of the main processing, that is, at the time of creating the DM transmission list will be described with reference to FIG. 16. FIG. 16 is a sequence diagram illustrating an operation of the potential customer estimation system 700 in a case where creating a DM transmission list. First, the person in charge of the credit card company inputs one or more natural language queries to the service request apparatus 600 (step S601). Next, the natural language query transmission unit 620 transmits a DM transmission list creation request including the natural language query to the potential customer estimation device 900 (step S602).

Next, the relevance calculation unit 444 requests the attribute information database 300 for the second attribute information of each customer (step S603). The attribute information database 300 transmits the second attribute information and the associated customer ID to the potential customer estimation device 400 in response to the request (step S604). Next, the relevance calculation unit 444 calculates a second relevance (step S605). The relevance calculation unit 444 performs each processing of steps S603 to S605 for each of a plurality of customers.

Next, the relevance calculation unit 444 requests the store attribute information about each store from the attribute information database 300 (step S606). The attribute information database 300 transmits the store attribute information and the associated store ID to the potential customer estimation device 900 in response to the request (step S607). Next, the relevance calculation unit 444 calculates a third relevance (step S608). The relevance calculation unit 444 performs each processing of steps S606 to S608 for each of a plurality of customers.

The order of executing steps S603 to S605 and steps S606 to S608 is not particularly limited, and steps S606 to S608 may be performed before steps S603 to S605. Steps S606 to S608 may be performed in parallel with steps S603 to S605. The case where the relevance calculation unit 444 calculates the relevance between the natural language query and the second attribute information or the store attribute information has been described in steps S603 to S608. However, in steps S603 to S608, as in the case described with reference to FIG. 8, the phrase identification unit 446 may identify the phrase from the natural language query, and the relevance calculation unit 444 may calculate the relevance between the phrase and the second attribute information or the store attribute information.

Next, the potential customer estimation unit 445 estimates a customer and a store having high similarity based on the second relevance and the third relevance (step S609). Specifically, the potential customer estimation unit 445 estimates that a customer whose second relevance is equal to or more than a predetermined numerical value and a store whose third relevance is equal to or more than a predetermined numerical value have high similarity. The potential customer estimation unit 445 outputs a combination of a customer and a store having high similarity as a DM transmission list (step S610) and transmits the DM transmission list to the service request apparatus 600 (step S611). In a case where receiving the DM transmission list, the person in charge of operating the service request apparatus 600 proposes DM transmission to an affiliated store described in the DM transmission list, for example.

As described above, in the potential customer estimation method according to the fourth example embodiment, since the store attribute information is used, the similarity between the store and the customer can be calculated. Therefore, it is possible to find a customer similar to the store and propose DM transmission to the store.

### Fifth Example Embodiment

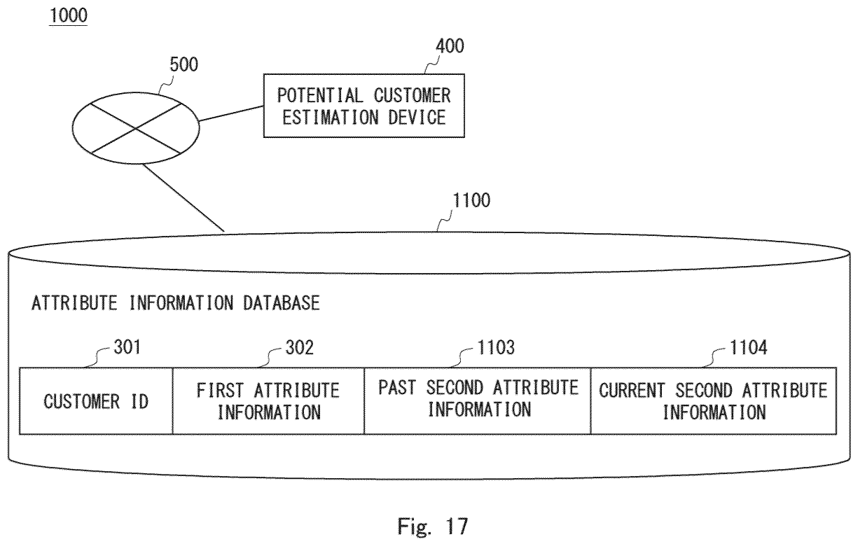

A fifth example embodiment is a modified example of the second example embodiment described above. In the fifth example embodiment, current second attribute information is identified based on past second attribute information, and is associated with a customer ID. FIG. 17 is a block diagram illustrating a configuration of a potential customer estimation system according to the fifth example embodiment. As illustrated in FIG. 17, a potential customer estimation system 1000 is different from the potential customer estimation system 200 illustrated in FIG. 3 in that an attribute information database 1100 is provided instead of the attribute information database 300. Since the potential customer estimation device according to the fifth example embodiment has the same configuration as the potential customer estimation device 400 described in the second example embodiment, the description thereof will be omitted.

As illustrated in FIG. 17, the attribute information database 1100 stores a first attribute information 302, a past second attribute information 1103, and a current second attribute information 1104 in association with a customer ID 301. The past second attribute information is second attribute information identified based on first attribute information extracted from a usage history of a credit card or the like and associated with a customer ID in a case where a potential customer is estimated in the past. The current second attribute information is second attribute information representing the current attribute of the customer.

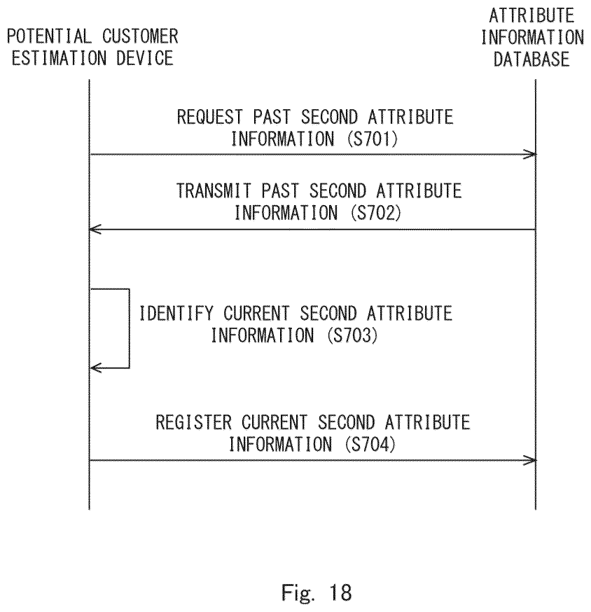

Next, an example of the operation of the potential customer estimation system 1000 at the time of pre-processing, that is, at the time of identifying the current second attribute information will be described with reference to FIG. 18. p FIG. 18 is a sequence diagram illustrating an operation of the potential customer estimation system 1000 in a case where identifying the current second attribute information. First, the second attribute information identification unit 442 requests the past second attribute information from the attribute information database 1100 (step S701). The attribute information database 1100 transmits the past second attribute information and the associated customer ID to the potential customer estimation device 400 (step S702). The second attribute information identification unit 442 identifies the current second attribute information based on the past second attribute information transmitted in step S702 (step S703), and registers the current second attribute information in the attribute information database 1100 in association with the customer ID (step S704).

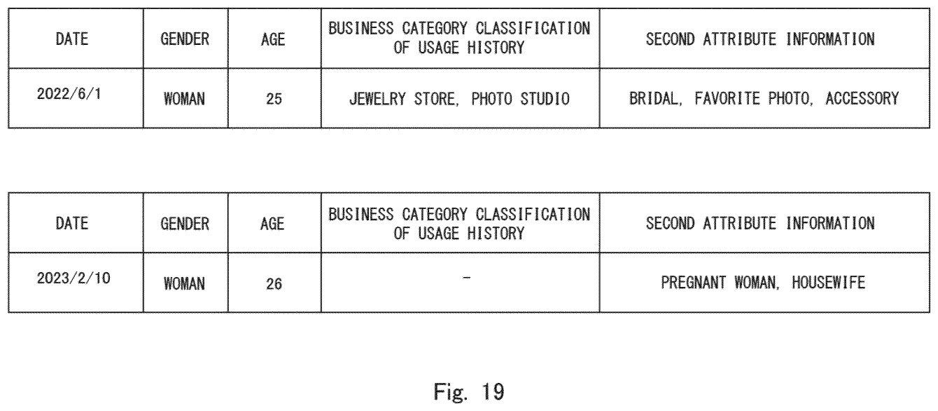

Next, an example of identifying the current second attribute information based on the past second attribute information will be described with reference to FIG. 19. FIG. 19 is a diagram illustrating an example of current and past second attribute information. In the example illustrated in FIG. 19, based on the first attribute information such as the business category classification, the gender, and the age of the usage history, “bridal”, “favorite photo”, and “accessory” are associated with the customer as the second attribute information (past second attribute information) as of Jun. 1, 2022. It is estimated from the first attribute information and the past second attribute information that the customer was “a young woman who is about to get married” as of Jun. 1, 2022. Considering the passage of years from a time point at which the past second attribute information and the past second attribute information were identified to the present, it seems that the customer is highly likely to be a “pregnant woman”. Therefore, in a case where identifying and associating the second attribute information (current second attribute information) as of Feb. 10, 2023 with the customer, the second attribute information identification unit 442 associates “pregnant woman” and “housewife” as the current second attribute information based on the past second attribute information. The second attribute information identification unit 442 may identify the current second attribute information based on the past second attribute information and the first attribute information such as the current usage history. In this case, the current second attribute information can be identified with high accuracy as compared with a case where the current second attribute information is identified only from the past second attribute information.

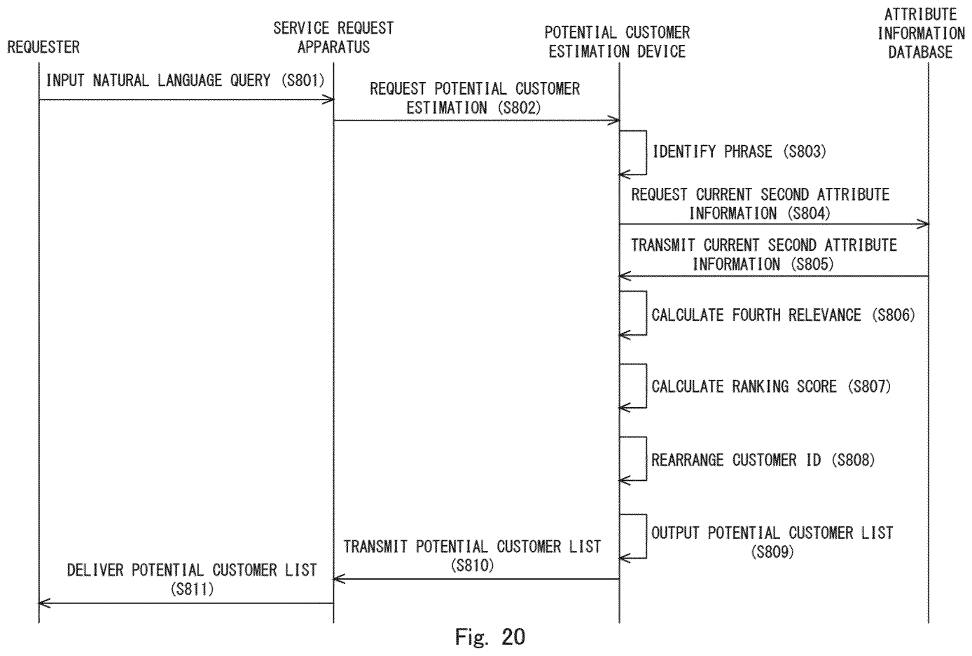

Next, an example of the operation of the potential customer estimation system 1000 at the time of the present processing, that is, at the time of estimating the potential customer based on the current second attribute information will be described with reference to FIG. 20. FIG. 20 is a sequence diagram illustrating an operation of the potential customer estimation system 1000 in a case where the potential customer is estimated based on the current second attribute information. First, the requester inputs one or more natural language queries to the service request apparatus 600 (step S801).

Next, the natural language query transmission unit 620 transmits a potential customer estimation request including the natural language query to the potential customer estimation device 400 (step S802). The phrase identification unit 446 identifies one or more phrases from the natural language query included in the potential customer estimation request (step S803).

Next, the relevance calculation unit 444 requests the attribute information database 300 for the current second attribute information of each customer (step S304). The attribute information database 300 transmits the current second attribute information and the associated customer ID to the potential customer estimation device 400 in response to the request (step S805). Next, the relevance calculation unit 444 calculates a fourth relevance (step S806). Next, the relevance calculation unit 444 calculates a ranking score based on the fourth relevance (step S807). The relevance calculation unit 444 performs steps S804 to S807 for each of a plurality of customers.

The potential customer estimation unit 445 rearranges the customer IDs in descending order of the ranking scores calculated in step S807 (step S808). The potential customer estimation unit 445 outputs a customer ID whose ranking score is a predetermined numerical value or more as a potential customer list (step S809), and transmits the potential customer list to the service request apparatus 600 (step S810). Upon receiving the potential customer list, the person in charge of operating the service request apparatus 600 delivers the potential customer list to the requester (step S811).

As described above, in the potential customer estimation method according to the fifth example embodiment, since the current second attribute information is identified based on the past second attribute information, more accurate current second attribute information can be associated with the customer. Therefore, a potential customer can be found more accurately.

### Other Example Embodiment

In the above-described example embodiments, the configuration of the hardware has been described, but the present disclosure is not limited thereto. The present disclosure can also be implemented by causing a CPU to execute a computer program.

In the above-described example, the program includes a command group (or software code) for causing the computer to perform one or more functions described in the example embodiment in a case where being read by the computer. The program may be stored in a non-transitory computer-readable medium or a tangible storage medium. By way of example, and not limitation, computer-readable media or tangible storage media include a random-access memory (RAM), a read-only memory (ROM), a flash memory, a solid-state drive (SSD) or other memory technology, CD-ROM, a digital versatile disc (DVD), Blu-ray (registered trademark) disc or other optical disk storage, a magnetic cassette, a magnetic tape, a magnetic disk storage, or other magnetic storage devices. The program may be transmitted on a transitory computer-readable medium or communication medium. By way of example, and not limitation, transitory computer-readable or communication media include electrical, optical, acoustic, or other forms of propagated signals.

### Example of Hardware Configuration

Hereinafter, a case where each functional component of the determination apparatus in the present disclosure is implemented by a combination of hardware and software will be described.

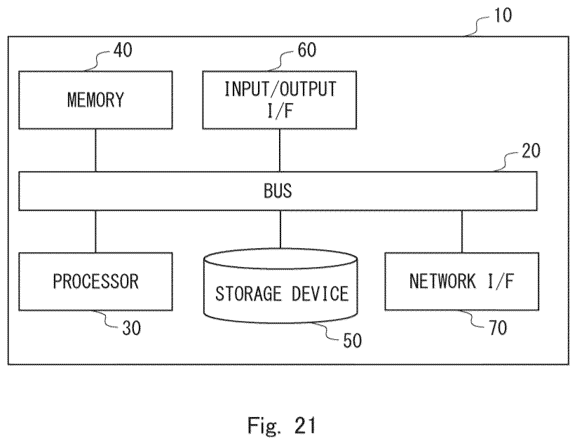

FIG. 21 is a block diagram illustrating a hardware configuration of a computer. The management device in the present disclosure can achieve the above-described functions by the computer 10 including the hardware configuration illustrated in the drawings. The computer 10 may be a portable computer such as a smartphone or a tablet terminal or may be a stationary computer such as a PC. The computer 10 may be a dedicated computer designed to implement each device or a general-purpose computer. The computer 10 can implement a desired function by installing a predetermined program.

The computer 10 includes a bus 20, a processor 30, a memory 40, a storage device 50, an input/output interface 60 (an interface is also abbreviated to an I/F), and a network interface 70. The bus 20 is a data transmission path used for the processor 30, the memory 40, the storage device 50, the input/output interface 60, and the network interface 70 to transmit and receive data to and from each other. Here, a method of connecting the processor 30 and the like to each other is not limited to the bus connection.

The processor 30 is any of various processors such as a CPU, a GPU, or an FPGA. The memory 40 is a main storage device implemented using a random access memory (RAM) or the like.

The storage device 50 is an auxiliary storage device implemented using a hard disk, an SSD, a memory card, a read only memory (ROM), or the like. The storage device 50 stores a program for implementing a desired function. The processor 30 reads the program into the memory 40 and executes the program to implement each functional component of each device.

The input/output interface 60 is an interface for connecting the computer 11 and an input/output device. For example, an input device such as a keyboard or an output device such as a display device are connected to the input/output interface 60. The network interface 70 is an interface for connecting the computer 11 to a network.

Although the example of the hardware configuration in the present disclosure has been described above, the above-described example embodiment is not limited thereto. According to the present disclosure, any processing can also be implemented by causing a processor to execute a computer program.

In the above-described example, the program includes a group of instructions (or software code) for causing a computer to perform one or more functions described in the example embodiments in a case where being read by the computer. The program may be stored in a non-transitory computer-readable medium or a tangible storage medium. As an example and not by way of limitation, computer-readable media or tangible storage media include random-access memory (RAM), read-only memory (ROM), flash memory, solid-state drive (SSD) or other memory technology, CD-ROM, digital versatile disc (DVD), Blu-ray® disc or other optical disk storage, magnetic cassettes, magnetic tape, magnetic disk storage or other magnetic storage devices. The program may be transmitted on a transitory computer-readable medium or communication medium. By way of example, and not limitation, transitory computer-readable or communication media include electrical, optical, acoustic, or other forms of propagated signals.

The present disclosure is not limited to the above example embodiments, and can be appropriately changed without departing from the scope. The present disclosure may be implemented by appropriately combining the example embodiments.

Some or all the above example embodiments may be described as the following Supplementary Notes, but are not limited to the following.

### Supplementary Note A1

A potential customer estimation device including:
a first attribute information extraction unit for extracting first attribute information included in consumption behavior information of a plurality of customers and associating the first attribute information with each associated customer;
a second attribute information identification unit for identifying second attribute information extended based on the first attribute information and associating the second attribute information with each associated customer;
a natural language query reception unit for receiving an input of one or more natural language queries indicating a customer image to be extracted;
a relevance calculation unit for calculating a second relevance between the one or more natural language queries and the second attribute information; and
a potential customer estimation unit for estimating a potential customer based on the second relevance.

### Supplementary Note A2

The potential customer estimation device according to Supplementary Note A1, in which the potential customer estimation unit calculates a score based on the second relevance for each of the customers, creates a ranking obtained by rearranging the customers based on the calculated score, and estimates a potential customer based on the second relevance or the ranking.

### Supplementary Note A3

The potential customer estimation device according to Supplementary Note A1 or A2, further including a phrase identification unit for analyzing the one or more natural language queries and identifying a phrase to be used for calculation of the second relevance,
in which the relevance calculation unit calculates the second relevance between the phrase and the second attribute information.

### Supplementary Note A4

The potential customer estimation device according to any one of Supplementary Notes A1 to A3, in which
the relevance calculation unit further calculates a first relevance between the one or more natural language queries and the first attribute information, and
the potential customer estimation unit estimates the potential customer based on the first relevance and the second relevance.

### Supplementary Note A5

The potential customer estimation device according to any one of Supplementary Notes A1 to A4, further including an estimation optimization unit for evaluating whether the estimation of the potential customer is proper based on an action history of the potential customer after the estimation, and enhancing estimation accuracy of the potential customer.

### Supplementary Note A6

The potential customer estimation device according to any one of Supplementary Notes A1 to A5, further including a store attribute information identification unit for identifying store attribute information extended based on business category information about each store, in which
the relevance calculation unit further calculates a third relevance between the one or more natural language queries and the store attribute information, and
the potential customer estimation unit estimates that a customer high in the second relevance and a store high in the third relevance are high in similarity.

### Supplementary Note A7

The potential customer estimation device according to any one of Supplementary Notes A1 to A6, in which
the second attribute information identification unit identifies current second attribute information based on past second attribute information assigned to each of the customers and associates the current second attribute information with the customer,
the relevance calculation unit calculates a fourth relevance between the one or more natural language queries and the current second attribute information, and
the potential customer estimation unit estimates a potential customer based on the fourth relevance.

### Supplementary Note B1

A potential customer estimation system including:
an attribute information database that stores identification information for identifying a plurality of customers and first attribute information and second attribute information on each customer in association with each other; and
a potential customer estimation device capable of communicating with the attribute information database, in which
the potential customer estimation device:
extracts first attribute information included in consumption behavior information of a plurality of customers and associates the first attribute information with each associated customer;
identifies second attribute information extended based on the first attribute information and associates the second attribute information with each associated customer;
receives an input of one or more natural language queries indicating a customer image to be extracted;
calculates a second relevance between the one or more natural language queries and the second attribute information; and
estimates a potential customer based on the second relevance.

### Supplementary Note B2

The potential customer estimation system according to Supplementary Note B1, in which the potential customer estimation device calculates a score based on the relevance for each of the customers, creates a ranking obtained by rearranging the customers based on the calculated score, and estimates a potential customer based on the relevance or the ranking.

### Supplementary Note B3

The potential customer estimation system according to Supplementary Note B1 or B2, in which
the potential customer estimation device further includes a phrase identification unit for analyzing the one or more natural language queries and identifying a phrase to be used for calculation of the second relevance, and
the relevance calculation unit calculates the second relevance between the phrase and the second attribute information.

### Supplementary Note B4

The potential customer estimation system according to any one of Supplementary Notes B1 to B3, in which
the relevance calculation unit further calculates a first relevance between the one or more natural language queries and the first attribute information, and
the potential customer estimation unit estimates the potential customer based on the first relevance and the second relevance.

### Supplementary Note B5

The potential customer estimation system according to any one of Supplementary Notes B1 to B4, in which the potential customer estimation device further includes an estimation optimization unit for evaluating whether the estimation of the potential customer is proper based on an action history of the potential customer after the estimation, and enhancing estimation accuracy of the potential customer.

### Supplementary Note B6

The potential customer estimation system according to any one of Supplementary Notes B1 to B5, in which
the potential customer estimation device further includes a store attribute information identification unit for identifying store attribute information extended based on business category information about each store,
the relevance calculation unit further calculates a third relevance between the one or more natural language queries and the store attribute information, and
the potential customer estimation unit estimates that a customer high in the second relevance and a store high in the third relevance are high in similarity.

### Supplementary Note B7

The potential customer estimation system according to any one of Supplementary Notes B1 to B6, in which
the second attribute information identification unit identifies current second attribute information based on past second attribute information assigned to each of the customers and associates the current second attribute information with the customer,
the relevance calculation unit calculates a fourth relevance between the one or more natural language queries and the current second attribute information, and
the potential customer estimation unit estimates a potential customer based on the fourth relevance.

### Supplementary Note C1

A potential customer estimation method causing a computer to execute:
extracting first attribute information included in consumption behavior information of a plurality of customers and associating the first attribute information with each associated customer;
identifying second attribute information extended based on the first attribute information and associating the second attribute information with each associated customer;
receiving an input of one or more natural language queries indicating a customer image to be extracted;
calculating a second relevance between the one or more natural language queries and the second attribute information; and
estimating a potential customer based on the second relevance.

### Supplementary Note C2

The potential customer estimation method according to Supplementary Note C1, further causing the computer to execute calculating a score based on the second relevance for each of the customers, creating a ranking obtained by rearranging the customers based on the calculated score, and estimating a potential customer based on the second relevance or the ranking.

### Supplementary Note C3

The potential customer estimation method according to Supplementary Note C1 or C2, further causing the computer to execute:
analyzing the one or more natural language queries and identifying a phrase to be used for calculation of the second relevance; and
calculating the second relevance between the phrase and the second attribute information.

### Supplementary Note C4

The potential customer estimation method according to any one of Supplementary Notes C1 to C3, further causing the computer to execute:
further calculating a first relevance between the one or more natural language queries and the first attribute information, and
estimating the potential customer based on the first relevance and the second relevance.

### Supplementary Note C5

The potential customer estimation method according to any one of Supplementary Notes C1 to C4, further causing the computer to execute evaluating whether the estimation of the potential customer is proper based on an action history of the potential customer after the estimation, and enhancing estimation accuracy of the potential customer.

### Supplementary Note C6

The potential customer estimation method according to any one of Supplementary Notes C1 to C5, further causing the computer to execute:
identifying store attribute information extended based on business category information about each store;
further calculating a third relevance between the one or more natural language queries and the store attribute information; and
estimating that a customer high in the second relevance and a store high in the third relevance are high in similarity.

### Supplementary Note C7

The potential customer estimation method according to any one of Supplementary Notes C1 to C6, further causing the computer to execute:
identifying current second attribute information based on past second attribute information assigned to each of the customers and associating the current second attribute information with the customer;
calculating a fourth relevance between the one or more natural language queries and the current second attribute information; and
estimating a potential customer based on the fourth relevance.

### Supplementary Note D1

A potential customer estimation program causing a computer to execute processing of:
extracting first attribute information included in consumption behavior information of a plurality of customers and associating the first attribute information with each associated customer;
identifying second attribute information extended based on the first attribute information and associating the second attribute information with each associated customer;
receiving an input of one or more natural language queries indicating a customer image to be extracted;
calculating a second relevance between the one or more natural language queries and the second attribute information; and
estimating a potential customer based on the second relevance.

### Supplementary Note D2

The potential customer estimation program according to Supplementary Note D1, further causing the computer to execute processing of: calculating a score based on the second relevance for each of the customers, creating a ranking obtained by rearranging the customers based on the calculated score, and estimating a potential customer based on the second relevance or the ranking.

### Supplementary Note D3

The potential customer estimation program according to Supplementary Note D1 or D2, further causing the computer to execute processing of:
analyzing the one or more natural language queries and identifying a phrase to be used for calculation of the second relevance; and
calculating the second relevance between the phrase and the second attribute information.

### Supplementary Note D4

The potential customer estimation program according to any one of Supplementary Notes D1 to D3, further causing the computer to execute processing of:
further calculating a first relevance between the one or more natural language queries and the first attribute information; and
estimating the potential customer based on the first relevance and the second relevance.

### Supplementary Note D5

The potential customer estimation program according to any one of Supplementary Notes D1 to D4, further causing the computer to execute processing of evaluating whether the estimation of the potential customer is proper based on an action history of the potential customer after the estimation, and enhancing estimation accuracy of the potential customer.

### Supplementary Note D6

The potential customer estimation program according to any one of Supplementary Notes D1 to D5, further causing the computer to execute processing of:
identifying store attribute information extended based on business category information about each store;
further calculating a third relevance between the one or more natural language queries and the store attribute information; and
estimating that a customer high in the second relevance and a store high in the third relevance are high in similarity.

### Supplementary Note D7

The potential customer estimation program according to any one of Supplementary Notes D1 to D6, further causing the computer to execute processing of:
identifying current second attribute information based on past second attribute information assigned to each of the customers and associating the current second attribute information with the customer;
calculating a fourth relevance between the one or more natural language queries and the current second attribute information; and
estimating a potential customer based on the fourth relevance.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2023-031927 filed on Mar. 2, 2023, the entire disclosure of which is incorporated herein.

### REFERENCE SIGNS LIST

100 potential customer estimation device
110 first attribute information extraction unit
120 second attribute information identification unit
130 natural language query reception unit
140 relevance calculation unit
150 potential customer estimation unit
200 potential customer estimation system
300 attribute information database
301 customer ID
302 first attribute information
303 second attribute information
400 potential customer estimation device
410 memory
430 storage unit
431 program
440 control unit
441 first attribute information extraction unit
442 second attribute information identification unit
443 natural language query reception unit
444 relevance calculation unit
445 potential customer estimation unit
446 phrase identification unit
500 network
600 service request apparatus
610 usage history database
611 customer ID
612 usage history
620 natural language query transmission unit
630 potential customer list reception unit
640 control unit
1200 potential customer estimation device
1247 estimation optimization unit
700 potential customer estimation system
800 attribute information database
801 store ID
802 store attribute information
900 potential customer estimation device
940 control unit
946 store attribute information identification unit
1000 potential customer estimation system
1100 attribute information database
1103 past second attribute information
1104 current second attribute information

What is claimed is:

1. A potential customer estimation device comprising:
at least one memory configured to store instructions, and
at least one processor configured to execute the instructions to:
extract first attribute information included in consumption behavior information of a plurality of customers and associating the first attribute information with each associated customer;
identify second attribute information extended based on the first attribute information and associating the second attribute information with each associated customer;
receive an input of one or more natural language queries indicating a customer image to be extracted;
calculate a second relevance between the one or more natural language queries and the second attribute information; and
estimate a potential customer based on the second relevance.

2. The potential customer estimation device according to claim 1, wherein the at least one processor is further configured to calculate a score based on the second relevance for each of the customers, create a ranking obtained by rearranging the customers based on the calculated score, and estimate a potential customer based on the second relevance or the ranking.

3. The potential customer estimation device according to claim 1, or the at least one processor is further configured to analyze the one or more natural language queries and identifying a phrase to be used for calculation of the second relevance, and calculate the second relevance between the phrase and the second attribute information.

4. The potential customer estimation device according to claim 1, wherein the at least one processor is further configured to:
calculate a first relevance between the one or more natural language queries and the first attribute information, and
estimate the potential customer based on the first relevance and the second relevance.

5. The potential customer estimation device according to claim 1, wherein the at least one processor is further configured to evaluate whether the estimation of the potential customer is proper based on an action history of the potential customer after the estimation, and enhance estimation accuracy of the potential customer.

6. The potential customer estimation device according to claim 1, wherein the at least one processor is further configured to:
identify store attribute information extended based on business category information about each store,
calculate a third relevance between the one or more natural language queries and the store attribute information, and
estimate that a customer high in the second relevance and a store high in the third relevance are high in similarity.

7. The potential customer estimation device according to claim 1, wherein the at least one processor is further configured to:
identify current second attribute information based on past second attribute information assigned to each of the customers and associates the current second attribute information with the customer,
calculate a fourth relevance between the one or more natural language queries and the current second attribute information, and
estimate potential customer based on the fourth relevance.

8-14. (canceled)

15. A potential customer estimation method causing a computer to execute:
extracting first attribute information included in consumption behavior information of a plurality of customers and associating the first attribute information with each associated customer;
identifying second attribute information extended based on the first attribute information and associating the second attribute information with each associated customer;
receiving an input of one or more natural language queries indicating a customer image to be extracted;
calculating a second relevance between the one or more natural language queries and the second attribute information; and
estimating a potential customer based on the second relevance.

16. A non-transitory computer-readable medium configured to store a potential customer estimation program causing a computer to execute processing of:
extracting first attribute information included in consumption behavior information of a plurality of customers and associating the first attribute information with each associated customer;
identifying second attribute information extended based on the first attribute information and associating the second attribute information with each associated customer;
receiving an input of one or more natural language queries indicating a customer image to be extracted;
calculating a second relevance between the one or more natural language queries and the second attribute information; and
estimating a potential customer based on the second relevance.

17. The non-transitory computer-readable medium configured to store the potential customer estimation program according to claim 16, further causing the computer to execute processing of: calculating a score based on the second relevance for each of the customers, creating a ranking obtained by rearranging the customers based on the calculated score, and estimating a potential customer based on the second relevance or the ranking.

18. The non-transitory computer-readable medium configured to store the potential customer estimation program according to claim 16, further causing the computer to execute processing of:
analyzing the one or more natural language queries and identifying a phrase to be used for calculation of the second relevance; and
calculating the second relevance between the phrase and the second attribute information.

19. The non-transitory computer-readable medium configured to store the potential customer estimation program according to claim 16, further causing the computer to execute processing of:
further calculating a first relevance between the one or more natural language queries and the first attribute information; and
estimating the potential customer based on the first relevance and the second relevance.

20. The non-transitory computer-readable medium configured to store the potential customer estimation program according to claim 16, further causing the computer to execute processing of evaluating whether the estimation of the potential customer is proper based on an action history of the potential customer after the estimation, and enhancing estimation accuracy of the potential customer.
